(19) United States
(12) Patent Application Publication
(10) Pub. No.: US 2004/0084810 A1
(43) Pub. Date: May 6, 2004

(54) Laser system for drilling and plating vias

(76) Inventors: Winco Kam-Chuen Yung, Hong Kong (HK); Esther Sau-Wai Leung, Hong Kong (HK); Mark D. Owen, Kowloon (HK)

Correspondence Address: JACKSON WALKER L.L.P., Suite 2100, 112 E. Pecan Street, San Antonio, TX, 78205, US

(21) Appl. No.: 10/286,582

(22) Filed: Nov. 1, 2002

(51) Int. Cl. B29C 35/08

(52) U.S. Cl. 264/400; 205/78

(57) ABSTRACT

A three-step method in which a printed circuit board (PCB) is laser drilled to form a via, and the internal walls of the via are plated with conductive material to connect conductive layers at the upper and lower ends of the via. In the first step a first laser removes a first portion of the board. In the second step a second laser removes a further portion of the board to form a via. In the third step a third laser ablates conductive material at the bottom of the via to plate the inner walls of the via.

### BACKGROUND TO THE INVENTION

1. Field of the Invention

The invention relates to systems for drilling and plating the inner wall of a via, in particular high aspect ration vias. A high aspect ration via is one where the depth-to-diameter ratio is greater than 1.

2. Background Information

In multi-layer electronic circuits through-vias, and blind-vias, in the printed circuit board connect conducting tracks on the different layers. Referring to FIG. 1 a is circuit board made of dielectric material 1 has conducting tracks 2, 3 on its upper and lower surfaces. The inner wall of vias 8 are plated with a conductive layer to connect the upper and lower conductive tracks 2,3. Typically, the inner walls of the via have been plated by electroplating.

The decrease in the size of electronic components, chips and bare board leads has increased the density of electronic packaging. In order to achieve this increase the vias 8 must be very small, for example less than 150 μm in diameter, and have a high aspect ratio. It is difficult to achieve high quality reliable interconnectivity with vias using conventional drilling and electroplating techniques.

To overcome the above problem laser drilling techniques have become common. U.S. Pat. No. 5,614,114 (Owen) discloses a method of through hole plating using an external substrate underneath the board and a UV laser of quadruple frequency, operating at 266 nm. This technique has the disadvantages of requiring an external substrate, increasing the manufacturing costs, and lacking reproducibility, which effects quality.

### SUMMARY OF THE INVENTION

It is an object of the present invention to provide a method of laser drilling and plating a board which improves on the prior art, or which provides a useful alternative.

According to the invention there is provided a method of drilling and plating a board comprising a plurality of layers of dielectric and conductive material, the method including:

generating a first laser having a power density above the ablation threshold of the dielectric and conductive materials,

directing the first laser at a region of the board to remove a first conductive layer and a first portion of a dielectric layer,

generating a second laser having a power density above the ablation threshold of the dielectric material and below the ablation threshold of the conductive material, directing the second laser at the region of the board to remove a second portion of the dielectric layer to form a via having an inner wall surface,

generating a third laser having a power density near the ablation threshold of the conductive materials, and

directing the third laser through the via at a second conductive layer proximate the inner wall surface for ablating at least a portion of the second conductive layer and distributing particles of conductive material onto the inner wall surface.

Preferably, the first laser is directed at a centre of the region and moved along a spiral path to a periphery of the region, and the second and third lasers are directed at the region and moved in a circular path around the periphery of the, region.

Preferably, the laser is a solid state laser operating at a wavelength of substantially between 200 nm and 400 nm.

Preferably, the via is less that 150 μm in diameter.

Preferably, the via has an aspect (depth to diameter) ratio of greater than 1.

Preferably, the method includes a further step of electroplating the board.

Preferably, the parameters of the third laser are in the following ranges:

Offset: 2 to 3 mm

Repetition Rate: 8 to 12 kHz

Average Power: 0.2 to 0.8 Watts

Bite size: 1 μm to 5 μm.

Preferably, the parameters of the third laser are:

Offset: 2 mm

Repetition Rate: 8 kHz

Average Power: 0.2 Watts

Bite size: 5 μm.

Further aspects of the invention will become apparent from the following description, which is given by way of example only.

### BRIEF DESCRIPTION OF THE DRAWINGS

Embodiments of the invention will now be described by way of example only and with reference to the accompanying drawings in which:

FIG. 1 illustrates a portion of a typical printed circuit board (PCB),

FIG. 2 illustrates a first step of drilling and plating a via according to the invention,

FIG. 3 illustrates a laser path for the first step,

FIG. 4 illustrates a second step of drilling and plating a via according to the invention,

FIG. 5 illustrates a laser path for the second, and a third, step,

FIG. 6 is a table of laser parameters for the first and second steps,

FIG. 7 is a table of laser parameters for the third step,

FIG. 8 is a graph of Plating Thickness verses Average Laser Power Density for the third step, and

FIG. 9 is a graph of Plating Thickness verses Laser Repetition Rate for the third step.

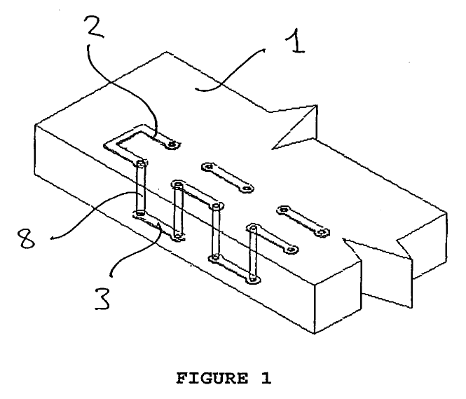

### DESCRIPTION OF THE PREFERRED EMBODIMENTS

The invention provides a three-step method in which a printed circuit board (PCB) is laser drilled to form a via, and the internal walls of the via are plated with conductive material to connect conductive layers at the upper and lower ends of the via.

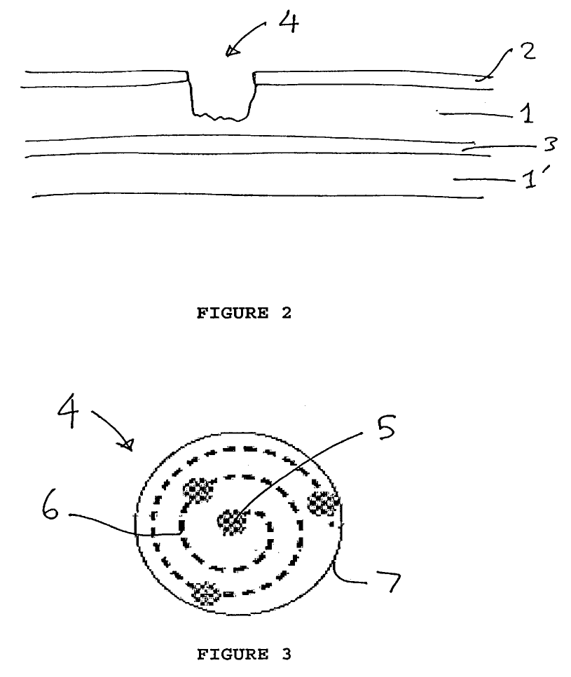

Referring to FIG. 2, the invention will be described with reference to a simple PCB comprising a layer of dielectric material 1 sandwiched between an upper conductive layer 2 and a lower conductive layer 3. The dielectric material 1 is epoxy resin with a thickness of 80 μm (microns). The conductive layers 2, 3 are copper with a thickness of about 12 μm.

A Nd:YAG diode-pumped laser is used for the drilling and plating. The frequency is tripled to give an operating wavelength of 355 nm. The laser is equipped with an acoustic optical Q-switch. The maximum average power of the laser is 2.0W. The laser pulse repetition rate ranges from 1 kHz to 20 kHz. An example of this type of laser processing system is the “ESI 5200 Drilling Station” from Electro Scientific Industries.

In alternative embodiments the invention may use a solid state laser operating at a wavelength of between 200 nm and 400 nm.

Blind via drilling requires the uniform removal of conductive and dielectric material to a desired depth by ablation with the laser. Proper depth control is achieved by controlling the laser fluence (pulse repetition rate). The first two steps in the method drill the via.

In the first Step a laser is generated with a high fluence beam which has a laser power density above the ablation threshold of the conductive layer 2 and dielectric layer 1. The laser is directed at a region 4 of the top copper layer 2 to remove a large portion of the conductive and dielectric layers 2, 1.

Referring to FIG. 3, the laser uses a spiral drilling technique in the first step. With the laser off, the laser beam positioner moves in an arc to the center 5 of a region 4 of the PCB. At the center 5 of the region 4, the laser turns on at the required repetition rate and the beam positioner moves in a widening spiral along a spiral path 6 to the outer periphery 7 of the region 4. The laser is turned off. The drilling step is repeated a specified number of times until a portion of the dielectric layer 1 has been removed to a depth short of the second (bottom) conductive layer 3. It will be apparent to the skilled addressee that the bite size of the laser is smaller than the size (diameter) of the via being formed.

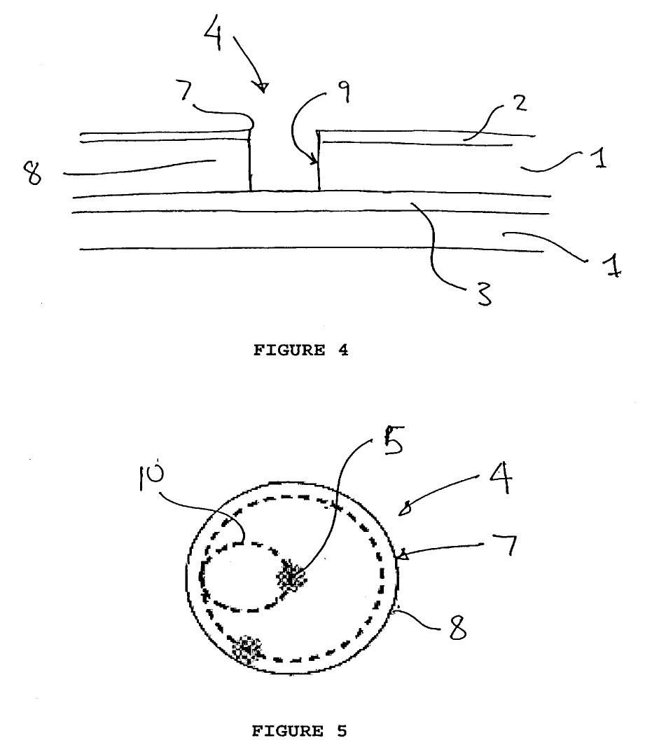

Referring to FIG. 4, the second step removes the remaining portion of the dielectric layer 1 to form a via 8 having an inner wall surface 9, and cleans the side walls of organic residue so that plating can occur. The laser fluence is set to a laser power density below the ablation threshold of the conductive material, but above that of the dielectric material. This allows the remaining portion of dielectric material from the via 8 to be removed, and the via cleaned ready for the third step, without damaging the second conductive layer 3.

Referring to FIG. 5, a trepan drilling technique is utilised in the second step. With the laser off, the beam positioner moves in an arc to the center 5 of the via 8. At the center of the via 8, the laser turns on at the required repetition rate. The beam positioner moves in an arc 10 toward the periphery 7 of the via 8 and continues around the periphery 7 the required number of times to finish forming and clean the via 8. The beam then moves in an arc to the center 5 of the via 8 and the laser turns off.

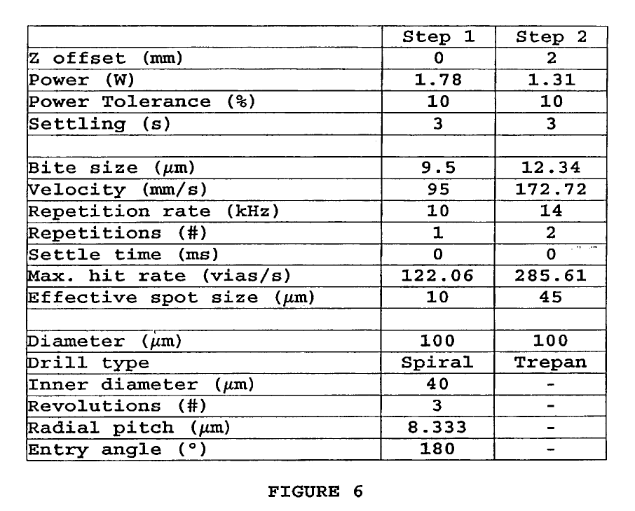

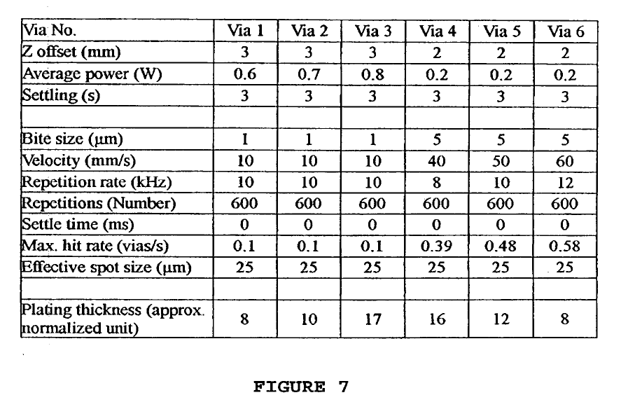

FIG. 6 is a table which shows the laser drilling parameters for the first and second steps when undertaken on the “ESI 5200 Drilling Station”. In the first step one pass around the spiral path 6 is required to remove the upper conductive layer 2 and first portion of dielectric material 1. In the second step two passes around the periphery 7 are required to remove the remaining portion of dielectric material 2 and clean the formed via 8.

The third step is to ablate a portion of the lower conductive layer 3 and deposit the conductive particles from this ablated portion onto the inner walls 9 of the via 8. To achieve this a very low fluence laser is used to ablate the upper surface of the lower conductive layer 3 without breaking through the conductive layer. The laser fluence is set to a laser power density substantially at the ablation threshold of the lower conductive layer 3. The layer is directed through the via 8 at conductive layer 3 which is proximate the bottom of the via 8. The ablation process causes rapid vaporisation which results in ejecting micron and sub-micron particles of copper from the bottom conductive layer of the via to splatter against the internal wall surface 9.

The third step plates the inner walls 9 of the via 8 with copper providing a conductive path between the upper and lower conductive layers 2,3. The thickness, and thus resistance, of the copper plating on the walls 9 is related to the laser repetition rate, bite-size and pulse energy.

The typical laser parameters to produce a via with acceptable copper thickness are: 3 mm offset, 10 kHz repetition rate, 0.6 to 0.8 Watt laser average power, and 1 μm bite size; and 2 mm offset, 8 to 12 kHz repetition rate, 0.2 Watt laser average power, and 5 μm bite size. Best results are obtained using 2 mm offset, 8 kHz repetition rate, a laser average power of 0.2 Watts and at a bite size of 5 μm.

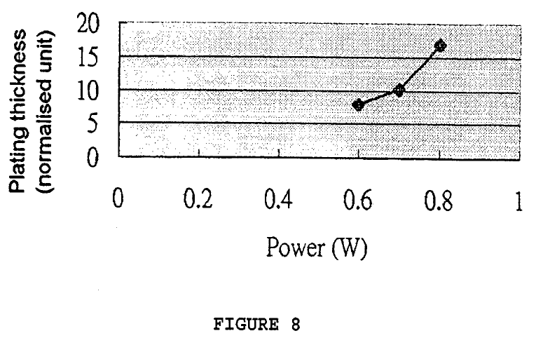

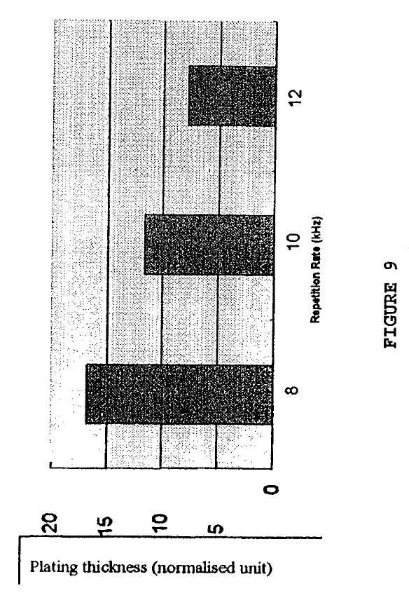

FIG. 7 is a table of typical examples of laser parameters and corresponding plating thickness for a via of 100 μm in diameter. The graph in FIG. 8 shows the relationship of Plating Thickness and Average Laser Power Density for vias 1 to 3 in FIG. 7. The graph in FIG. 9 shows the relationship of Plating Thickness and Laser Repetition Rate for vias 4 to 6 in FIG. 7.

The current invention improves on the prior art as it allows plating of blind vias using conductor planes in-situ in the PCB.

Embodiments of the invention have been described, however it is understood that variations, improvements or modifications can take place without departure from the spirit of the invention or scope of the appended claims.

What we claim is:

1. A method of drilling and plating a board comprising a plurality of layers of dielectric and conductive material, the method including:
generating a first laser having a power density above the ablation threshold of the dielectric and conductive materials,
directing the first laser at a region of the board to remove a first conductive layer and a first portion of a dielectric layer,
generating a second laser having a power density above the ablation threshold of the dielectric material and below the ablation threshold of the conductive material,
directing the second laser at the region of the board to remove a second portion of the dielectric layer to form a via having an inner wall surface,
generating a third laser having a power density near the ablation threshold of the conductive materials, and
directing the third laser through the via at a second conductive layer proximate the inner wall surface for ablating at least a portion of the second conductive layer and distributing particles of conductive material onto the inner wall surface.

2. The method of claim 1 in which the first laser is directed at a centre of the region and moved along a spiral path to a periphery of the region, and the second and third lasers are directed at the region and moved in a circular path around the periphery of the region.

3. The method of claim 1 wherein the laser is a solid state Nd:YAG laser operating at a wavelength of substantially between 200 nm and 400 nm.

4. The method of claim 1 in which the via is less that 150 μm in diameter.

5. The method of claim 1 in which the via has a depth to diameter ratio of greater than 1.

6. The method of claim 1 further including electroplating the board.

7. The method of claim 1 wherein the parameter of the third laser are in the following ranges:
Offset: 2 to 3 mm
Repetition Rate: 8 to 12 kHz
Average Power: 0.2 to 0.8 Watts
Bite size: 1 μm to 5 μm.

8. The method of claim 1 wherein the parameter of the third laser are:
Offset: 2 mm
Repetition Rate: 8 kHz
Average Power: 0.2 Watts
Bite size: 5 μm.
